(19) United States
(12) Patent Application Publication
(10) Pub. No.: US 2014/0256380 A1
(43) Pub. Date: Sep. 11, 2014

(54) VEHICLE MOUNTED CELL PHONE DOCKING STATION

(71) Applicants: PHILLIP ORTEGA, Santa Fe, NM (US); JOANNA ABEYTA, Santa Fe, NM (US)

(72) Inventors: PHILLIP ORTEGA, Santa Fe, NM (US); JOANNA ABEYTA, Santa Fe, NM (US)

(21) Appl. No.: 13/785,024

(22) Filed: Mar. 5, 2013

(51) Int. Cl. H04M 1/60

(52) U.S. Cl. CPC H04M 1/6075
USPC 455/557

(57) ABSTRACT

A cellphone docking station for receiving a cellphone, where the docking station includes: a receptacle, where the receptacle receives the cellphone; connectors within the receptacle, where the connectors connect to the cellphone and enable interactive command transfer between the docking station and cellphone; software stored in the docking station, where the software enables voice command interchange between the cellphone and docking station; and functionality indicators, where the functionality indicators relate to functions associated with the cellphone. The functionality indicators may include call activation, text messaging, voice mail, music, navigation and emergency call. In one embodiment, tabs may be provided on the inner walls of the receptacle. The docking station may also supply power to the cellphone within the receptacle.

### BACKGROUND OF THE INVENTION

1. Field of Invention

The present invention relates to a cell phone docking station that may be inserted as a console in a motor vehicle.

2. Description of Related Art

It is well known computing docking stations are available for various types of mobile electronic devices. Originally docking stations were utilized for laptop computers providing a means to dock or install the computer in a stationary position and provide sufficient power to the computer for operational purposes. Through the expansive use of handheld devices such as cell phones and PDAs docking stations have evolved to provide stationary positions to dock a portable electronic device such as a cell phone or a smart phone. Primarily the docking stations provide a power source and charging station for the electronic device however some docking stations provide peripheral connections and the ability to enhance the functionality of the receptive device. In particular, some docking stations allow an individual to input commands and features associated with the electronic device that is plugged into the docking station.

Many individuals utilize their cell phones while operating a motor vehicle. However it is imperative that the individual operating a motor vehicle has a hands-free device or other device to ensure that in addition to talking on the cell phone the individual operates the motor vehicle safely. Consequently, several mounting devices have been developed to mount a cell phone in the motor vehicle during operation. However many times with the vehicle-mounted devices the individual may still have to physically interact with the cell phone in order to use the phone for the various functions associated with it. It would therefore be advantageous to have a docking station installed in a vehicle that enables wireless voice-activated commands to be transmitted and used with the cell phone.

### SUMMARY OF THE INVENTION

The present invention relates to a cellphone docking station comprising: a receptacle, where the receptacle receives a cellphone; connectors within the receptacle, where the connectors connect to the cellphone and enable interactive command transfer between the docking station and cellphone; software stored in the docking station, where the software enables voice command interchange between the cellphone and docking station; and functionality indicators, where the functionality indicators relate to functions associated with the cellphone. The functionality indicators may include call activation, text messaging, voice mail, music, navigation and emergency call. In one embodiment, tabs may be provided on the inner walls of the receptacle. The docking station may also supply power to the cellphone within the receptacle.

### BRIEF DESCRIPTION OF DRAWINGS

FIG. 1 depicts a front panel of a cell phone docking station in accordance with the present invention.

FIG. 2 depicts a side view of a cell phone docking station in accordance with the present invention.

FIG. 3 depicts a sectional view of the docking station in accordance with the present invention.

### DETAILED DESCRIPTION

The present invention relates to a docking station that may be inserted as a console in a motor vehicle. The cell phone docking station according to present invention provides a receptacle for the insertion of a cell phone and in one particular embodiment a smart phone. The phone may be received by the receptacle and placed in electronic contact with the docking station through connectors within the receptacle. These connectors also provide the transmission of commands to the phone through the docking station. The docking station further includes functionality indicators along the front panel to indicate the activated function related to the cell phone. The cell phone is operated through the use of voice-activated commands that activate various functions associated with the cell phone.

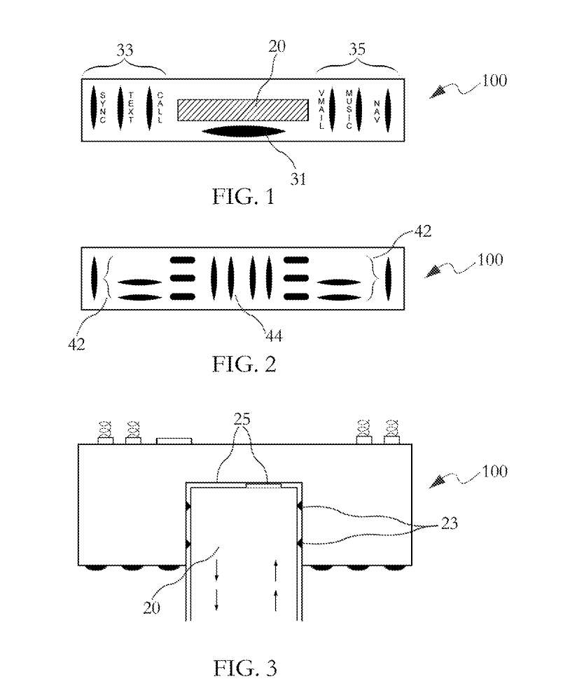

In reference to FIG. 1, a Cell Phone Docking Station 100 is depicted. The Cell Phone Docking Station 100 includes a cell phone receptacle 20 and a series of function indicators 33, 35. Further an emergency indicator 31 is also depicted. The emergency indicator 31 may be associated with a 911 call that is directly dialed through the use of a voice-activated command.

When activated this phone connects directly to a 911 operator through the voice activation command associated with the Docking Station 100.

The docking station 100 further includes connectors 25 that are shown in FIG. 3. FIG. 3 depicts a sectional top view of the docking station 20. As shown, the docking station 20 provides an opening for the insertion of a cell phone. Connectors 25 were provided to supply power and to allow transmission of voice-activated commands to the cell phone. Further within the cell phone receptacle 20 are tabs 23 which were placed on each side of the receptacle 20. These tabs provide the means to snuggly fit the cell phone within the receptacle 20.

In reference to FIG. 2, a side view of the docking station 100 is depicted. As depicted in the side view a series of vents are provided along the side panel of the docking station. Further additional tabs 42 are provided so that the docking station may be securely placed within an opening in the motor vehicle console.

During operation the docking station 100 receives voice-activated commands from a user. The user may activate a call function, messaging, voice mail, texting or other functions related to the cell phone within the receptacle 20. Software stored on a hard drive in the docking station enables voice command interchange between the cellphone and docking station 100. The voice-activated commands initiate the cell phone operation once the cell phone is placed within the Cell Phone Receptacle 20. Consequently, the docking station provides a voice-activated command station that allows a user to utilize the cell phone functions through voice activation. Further the cell phone is charged through the connectors 25 so that the cell phone remains charged during operation. The instant invention has been shown and described in what it considers to be the most practical and preferred embodiments. It is recognized, however, that departures may be made there from within the scope of the invention and that obvious modifications will occur to a person skilled in the art.

What is claimed is:

1. A cellphone docking station comprising:
a. a receptacle, where the receptacle receives a cellphone;
b. connectors within the receptacle, where the connectors connect to the cellphone and enable interactive command transfer between the docking station and cellphone;
c. software stored in the docking station, where the software enables voice command interchange between the cellphone and docking station; and
d. functionality indicators, where the functionality indicators relate to functions associated with the cellphone.

2. The cellphone docking station according to claim 1, where the functionality indicators include call activation, text messaging, voice mail, music, navigation and emergency call.

3. The cellphone docking station according to claim 1, where tabs are provided on the inner walls of the receptacle.

4. The cellphone docking station according to claim 1, where the docking station supplies power to the cellphone within the receptacle.
